(19) United States
(12) Patent Application Publication
(10) Pub. No.: US 2026/0318947 A1
(43) Pub. Date: Oct. 15, 2026

(54) SCANNING MICROWAVE MICROSCOPY USING A MEDIATOR LAYER

(71) Applicant: EIDGENOESSISCHES INST FUER METROLOGIE METAS, Wabern (CH)

(72) Inventors: Johannes HOFFMANN, Bremgarten (CH); Bruno ECKMANN, Spiegel b. Bern (CH)

(21) Appl. No.: 19/482,515

(22) PCT Filed: May 25, 2023
(86) PCT No.: PCT/EP2023/064057

§ 371 Date: Nov. 7, 2025

(51) Int. Cl. G01Q 30/14; G01N 22/00; G01Q 10/02; G01Q 20/02; G01Q 70/06

(52) U.S. Cl. CPC G01Q 30/14; G01Q 10/02; G01Q 20/02; G01Q 70/06; G01N 22/00

(57) ABSTRACT

In a method for scanning a sample (4) using Scanning Micro wave Microscopy, a measurement is performed by passing the sample (4) past a probe head (2). The probe head (2) has insulating substrate (6) and an array of sampling tips (10) arranged on the substrate. In the measurement, AC probe signals are fed to the sampling tips (10), and the amplitudes and/or phases of a plurality of returning reflected or transmitted signals returning from the sampling tips (10) is measured. Spatially resolved properties of the sample (4) are derived from the return signals. In order to increase the coupling between the probe head (2) and the sample (4), the gap (24 ) between the sampling tips (10) and the sample (4) is filled with a liquid and/or solid mediator layer (26). This technique allows to have a comparatively large gap (24) between the probe head (2) and the sample (4), making the arrangement robust and insensitive to small mechanical placement variations of the sampling tips (10).

### TECHNICAL FIELD

The present invention relates to a method for scanning a sample using Scanning Microwave Microscopy as well as to an apparatus for performing Scanning Microwave Microscopy.

### BACKGROUND ART

In Scanning Microwave Microscopy (SMM), a sample is probed by an evanescent electric wave e.g. in the GHz range. In a typical configuration, a metallic tip or another electrically conductive sampling tip is approached to the sample, and a microwave probe signal is coupled into the tip, probing the sample under test. Distance control can be achieved by measuring and controlling e.g., shear forces on the tip, laser deflection (on cantilever-based systems), or tunneling current, see Z. Chu, L. Zheng, and K. Lai, “Microwave Microscopy and Its Applications,” Ann. Rev. Mater. Res., vol. 50, pp. 105-130, 2020, doi: 10.1146/annurev-matsci-081519-011844. Such systems can achieve a high spatial resolution but often lack robustness, measurement speed, and ease of use. Consequently, SMM, like other scanning probe microscopy techniques, is used exclusively off-line and in laboratories.

S. Ernst et al. in “A Planar Scanning Probe Microscope—Supporting Information”, ACS Photonics 2019, 6, 2, 327-331, https://doi.org/10.1021/acsphotonics.8b01583, developed a planar scanning probe microscope for NV centers on a cantilever based system with optical distance control. Other designs avoiding fragile nanoscopic tips were developed by e.g.
Liu et al. [3], Soltani et. al., “Robust Tipless Positioning Device for Near-Field Investigations: Press and Roll Scan (PROscan),” ACS Nano, vol. 16, no. 8, pp. 12831-12839, 2022, doi:10.1021/acsnano.2c05047.,
Soltani et. al. “Biosensing with a scanning planar Yagi-Uda antenna,” Biomed. Opt. Express, Vol. 13, No. 2, p. 539, 2022, doi: 10.1364/boe.445402, and
Guo et al. “A flexible nitrogen-vacancy center probe for scanning magnetometry,” Rev. Sci. Instrum., vol. 92, no. 5, 2021, doi:10.1063/5.0040679.

In order to increase the throughput of scanning probe microscopes, various designs using 1D or 2D arrays of electrodes were proposed and implemented, e.g. by Cortés-Salazar et al. “Soft microelectrode linear array for scanning electrochemical microscopy,” Anal. Chem., vol. 82, no. 24, pp. 10037-10044, 2010, doi: 10.1021/ac1019304 for electrochemical microscopy or Zhou et al. “Apertureless cantilever-free pen arrays for scanning photochemical printing,” Small, vol. 11, no. 8, pp. 913-918, 2015, doi: 10.1002/smll.201402195 for scanning photochemical printing.

U.S. Pat. No. 10,989,736 describes an optical scanning head having a plurality of tips mounted to an elastic “compliant” layer, which allows to perform an AFM-type measurement on a sample at several points at a time, thereby increasing the speed of measurement.

### DISCLOSURE OF THE INVENTION

The problem to be solved by the present invention is to provide a method and apparatus that provide a fast, robust, and reliable means to perform Scanning Microwave Microscopy.

This problem is solved by the method and apparatus of the independent claims.

Accordingly, the method for scanning a sample using Scanning Microwave Microscopy comprises at least the step of performing a measurement by passing a sample past a probe head. The probe head has a substrate and an array of sampling tips arranged on said substrate. In this context, “passing a sample past a probe head” is to be understood such that the method includes moving the sample relative to the probe head (by moving the sample, the probe head, or both) in a direction parallel to the sample-facing surface of the substrate of the sampling tips. Further, the expression “arranged on said substrate” is to be understood such that the sampling tips are mounted in and/or on the substrate.

The measurement includes the following measurement steps:
Feeding AC probe signals to the sampling tips, i.e. the probe signals are applied to the sampling tips.
Measuring amplitudes and/or phases of a plurality of return signals returning from the sampling tips. If both the amplitude and phase are to be measured, they may e.g. be measured as peak-to-peak amplitude and phase shift angle of the return signal or as real and imaginary parts of the return signal. In this manner, as explained in more detail below, the reflection at given tips and/or the transmission(s) between different tips can be measured.
Deriving spatially resolved properties of the sample from the return signals. This may e.g. include the steps of storing and/or displaying the amplitudes and/or phases as a function of their relative positions on the sample.

During the measurement, the gap between the sampling tips and the sample is filled by a liquid and/or solid mediator layer.

Such a mediator layer has a higher relative permittivity than a gas or vacuum, or it may have an anisotropic conductivity with the conductivity along the direction from the probe head to the sample being larger than the one of a gas or vacuum. Thus, the electric interaction between the sampling tips and the sample is increased, which allows to operate the sampling tips at a larger distance from the sample, thereby rendering the setup less sensitive to surface unevenness of the sample and placement tolerances of the sampling tips.

Advantageously, for a good electric separation of the sampling tips, the substrate is electrically insulating.

In an advantageous embodiment, the mediator layer comprises a liquid. Liquids easily adapt to the surface contour of both the probe head and the sample, and they generate only small shear forces as the sample is moved past the probe head.

Advantageously, the mediator layer consists of a liquid. This makes it simple to apply the mediator layer.

The liquid of the mediator layer may e.g. comprise at least 50%, in particular at least 90% water. (All percentages herein are percentages by weight unless otherwise noted.) This embodiment provides particularly good results due to the high relative permittivity of water. Other liquid mediator materials are discussed below.

The mediator layer may also comprise a solid. In particular, the mediator may consist of a solid. Solid mediators can be more easily removed from the sample after the measurement and/or prevent an undesired wetting of the sample. Also, they have a better defined thickness than liquid mediators. Further, solid mediators allow for galvanic contacts and improved signal quality at elevated frequencies whereas liquid mediators only work through capacitive coupling for elevated frequencies and through ionic coupling for low frequencies.

The mediator layer may comprise or consist of a mediator film. This film can be inserted between the probe head and the sample, e.g. in a roll-to-roll process as described below.

Advantageously, the mediator layer is positioned on the sample prior to performing the measurement, and it is removed from the sample after performing the measurement, i.e. it is only used during the measurement. Alternatively, the mediator layer is positioned on the probe head prior to performing the measurement, and it is removed from the probe head after performing the measurement, i.e. it is again only used during the measurement

In yet a further advantageous embodiment, the method comprises the following steps:
Shining probe light transversally through the substrate.
Detecting a reflection of the probe light returning from the substrate. This reflection is caused by the light interacting with the substrate and the sample below it. As described in more detail below, the reflection depends on the tilt and/or the distance between the probe head and the sample and can be used to measure these parameters.
Controlling a relative distance and/or tilt between the probe head and the sample using the reflection.

This allows to control the position of the probe head with respect to the sample, in particular in automated manner.

The thickness of the mediator layer should be large enough to account for the positioning tolerances between the sampling tips and the sample as well as to account for the surface roughness of the sample. Advantageously, the thickness is at 10 nm, e.g. for semiconductor samples, and e.g. at least 5 μm for battery electrodes.

The maximum thickness of the mediator layer depends on the mediator layer material. For liquid mediator layers or isotropic solid mediator layers, the mediator layer is advantageously smaller than the average distance between neighboring sampling tips in order to keep crosstalk low. If an anisotropic solid mediator layer is used, the mediator layer may be thicker.

As mentioned, the invention also relates to an apparatus for scanning a sample using Scanning Microwave Microscopy, in particular for carrying out the method of the invention. Such an apparatus comprises at least the following elements:
A probe head having an insulating substrate and an array of sampling tips arranged on or in said substrate.
One or more AC signal sources electrically connected to the sampling tips. The signal sources are provided for applying AC probe signals to the sampling tips. They may e.g. include individual signal generators, or they may use one or more common signal generators.
A plurality of amplitude and/or phase detectors electrically connected to the sampling tips. The detectors are structured and adapted to detect the amplitude and/or phase of the return signals returning from the sampling tips.

The electrical connection can e.g. be a galvanic, direct connection, or it may be a capacitive connection able to pass the AC signals used in the measurements.
A sample carrier: The sample carrier is adapted to hold the sample in defined spatial relationship within measurement range of the probe head.
A depositing device for depositing a liquid and/or solid mediator layer onto the sample. This device may e.g. include one or more nozzles to deposit the mediator (e.g. as a liquid or in particulate form) onto the sample in order to form a mediator layer, and/or it may include a lamination mechanism to laminate the mediator layer on a surface of the sample.

Advantageously, the apparatus further comprises a displacement mechanism: This mechanism is adapted and structured to displace a sample in the sample carrier past the probe head. It may e.g. include a translational stage mounted to the sample carrier and/or the probe head. Or it may e.g. include rollers if the sample can be conveyed in a roll-to-roll process.

In a further embodiment, the mediator may be applied to the sample e.g. using a printing or stamping process, such as inkjet printing.

In the method or apparatus, the probe head advantageously comprises a regular array of at least three sampling tips arranged on said substrate, i.e. the distance between any two neighboring sampling tips along a given direction is the same. Advantageously, there are at least 4, in particular at least 8, sampling tips.

The array may be a one-dimensional array, in which case the sample is advantageously moved, in respect to the probe head, in a direction transversally to the array.

However, the array may also be a two-dimensional array.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a schematic, sectional view of a first embodiment,

FIG. 2 shows a schematic, sectional view of a second embodiment,

FIG. 3 shows a schematic, sectional view of a third embodiment,

FIG. 4 shows a view of an embodiment with connectors and leads on the side of the probe head facing away from the sample,

FIG. 5 shows a probe head with a one-dimensional array of sampling tips and its movement during the measurement,

FIG. 6 shows a probe head with a two-dimensional array of sampling tips and its movement during the measurement,

FIG. 7 shows a block diagram of example circuitry for generating and analyzing the electrical signals,

FIG. 8 illustrates raw data (left) and processed data (right) obtained for adjacent areas of the sample, and

FIG. 9 illustrates yet another embodiment having a displacement detector.

### MODES FOR CARRYING OUT THE INVENTION

### Definitions

“A method for scanning a sample using Scanning Microwave Microscopy” as used herein is advantageously defined as a method of assessing the electric properties of a surface of the sample by scanning the surface by means of at least one sampling tip while measuring the reflection of AC probe signals having a frequency of at least 100 MHz, in particular of at least 500 MHz for better spatial resolution. In particular, the frequency is between 0.005 GHz and 100 GHz.

Advantageously, as described elsewhere, the substrate is “transparent”. This is to be understood such that the substrate has (when ignoring reflections at its sample-facing surface) an optical transmission of at least 33%, in particular of at least 80%, at the wavelength of the probe light that is used for controlling the distance and/or tilt between the probe head and the sample. The optical reflection at the sample-facing surface of the substrate is discussed in the section “Positioning sensor” below.

### Overview, First Embodiment

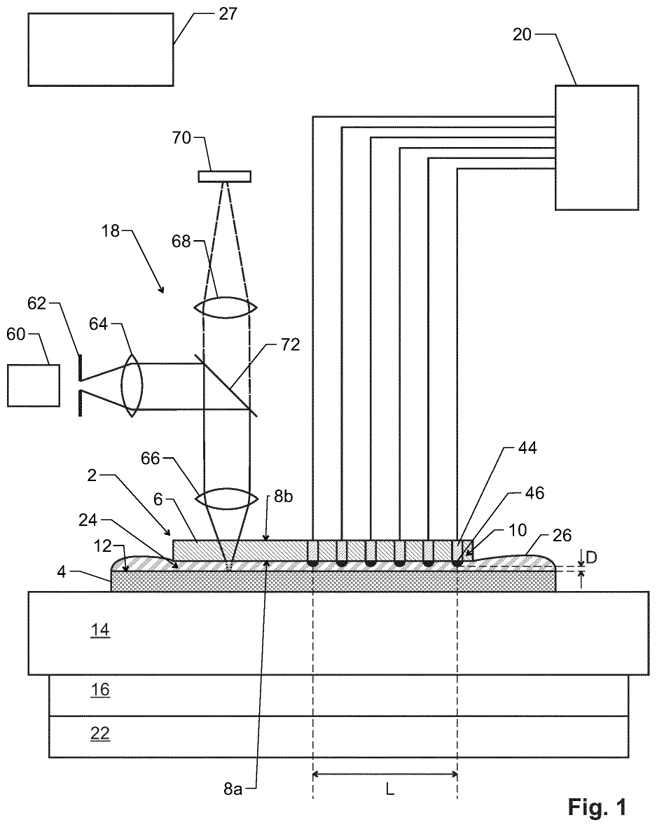

FIG. 1 illustrates a first embodiment of the measurement method and apparatus as well as some general concepts that can also be applied to other embodiments of the technique.

The measurement is carried out by means of a probe head 2 that is brought into proximity of a sample 4. Probe head 2 has an insulating, planar substrate 6, e.g. of glass, having a first side 8a arranged to face, during a measurement, the sample 4, and a second side 8b opposite first side 8a and facing away from sample 4.

Probe head 2 further comprises a plurality of sampling tips 10 immovably arranged on first side 8a of substrate 6. “Immovably”, in this context, expresses that the position of the sampling tips 10 is fixed in respect to substrate 6, i.e. they are rigidly connected to substrate 6 and do not move, in respect to substrate 6, during a measurement. (This is in contrast to devices where the sampling tip(s) is/are mounted on flexible levers or other flexible means the position of which varies with the relative distance between the tip and the sample.) Advantageously, “immovably” is to express that, during a measurement, the sampling tips do not move, in respect to the substrate, by more than 50 nm. A design where the sampling tips 10 are immovable in respect to the substrate provides for a more rugged and robust probe head.

Sample 4 can be any type of sample suitable for being probed in an SMM process. Examples of advantageous samples are provided in the section “Samples” below. Typically, it has a substantially flat surface 12 to be sampled by probe head 2. During the measurement, surface 12 faces probe head 2.

Sample 4 is mounted on a sample carrier 14. Carrier 14 may e.g. be a simple mounting stage that sample 4 is affixed to, but other types of carriers can be used as well.

The distance D between the sampling tips 10 and sample 4 is small, advantageously in a range between 10 nm and 5 μm, such that the evanescent electrical fields at the tips 10 have a strong interaction with the sample. On the other hand, the array of the sampling tips 10 extends, in at least one direction parallel to first surface 8a of probe head 2, over a length L of at least 5 μm, in particular of at least 250 μm. Hence, the distance D as well as the tilt (parallelism) of probe head 2 in respect to sample 4 is advantageously monitored and, if necessary, corrected.

To do so, the apparatus comprises an actuator 16 acting on sample carrier 14 and/or on probe head 2 to change the distance and/or tilt between the two components. For example, actuator 16 may be a combination of one or more piezo actuators.

Further, the apparatus may comprise a positioning sensor 18 for monitoring the relative distance and tilt between probe head 2 and sample 4. Examples of such positioning sensors 18 are described in the section “Positioning sensor” below.

The apparatus further comprises processing electronics 20 generating probe signals and feeding them to the sampling tips 10. These signals are reflected from the sampling tips 10, thereby generating return signals going back into the processing electronics 20. Advantageously, processing electronics 20 is adapted to individually measure the amplitude and/or phase of the return signal from each sampling tip 10.

The amplitude and phase of the return signals depend on the impedance of the sampling tips 10, i.e. on the electrical properties of the components close to the sampling tips 10. In particular, if sample 4 is sufficiently close to the sampling tips, the amplitude and phase of the individual return signal depend on the local electrical properties of sample 4 at the location of the individual sampling tips 10. Hence, processing the return signals allows to derive local information about sample 4.

More details about processing electronics 20 are provided in the section “Signal processing” below.

In order to process an extended area of sample 4, sample 4 is advantageously displaced in respect to probe head 2 in at least one direction parallel to its surface 12. Subsequent measurements during such a displacement allow to probe different locations of sample 4. For this purpose, the apparatus may comprise a displacement mechanism 22, which may e.g. again be a dielectric actuator or an actuator using mechanical drive means, such as stepper motors. In the example of FIG. 1, displacement mechanism 22 is shown to act on sample carrier 14, but it may e.g. also move sample 4 directly (see examples below), and/or it may move probe head 2.

More information about the scanning process and different sampling tip configurations optimized for certain scanning processes is provided in the section “Scanning process” below.

As mentioned above, the gap 24 between sampling tips 10 and sample 4 is filled with a mediator layer 26, which can be a solid, a liquid, or a combination of a solid and a liquid. By using such a mediator layer 26, which has a relative permittivity larger than vacuum, the electric coupling between the sampling tips 10 and the structures at or close to surface 12 of sample 4 can be improved.

More details about mediator layer 26 are provided in the next section.

The apparatus shown herein further comprises a control unit 27, which may e.g. be a computer or microprocessor including interface circuitry to control actuator 16, displacement mechanism 22, sensor 18, and processing electronics 20 and to receive signals therefrom. It is programmed to control the apparatus using the method described herein.

### Mediator

As mentioned, mediator layer 26 may be a liquid. Liquids readily adapt to the surfaces 12 and 8a of sample 4 and probe head 2, respectively, and they do not significantly resist a displacement of these two parts during a scanning process.

As mentioned above, the mediator liquid may comprise at least 50%, in particular at least 90%, of water. Water has a large relative permittivity and therefore provides a good coupling between the sampling tips 10 and sample 2.

In particular for medical applications, the mediator may be blood or NaCl solutions, which typically contain more than 90% of water.

In another embodiment, the mediator layer can e.g. comprise at least 10%, in particular at least 20%, in a preferred embodiment at least 80%, of an organic liquid.

In particular, the organic liquid may comprise at least one of the following high-permittivity liquids:
Ethylene carbonate: This material has a large relative permittivity, see e.g. Xinli You et al 2015, ECS Trans. 69 107. When using this material, the measurement should advantageously be carried out at temperatures of at least 34 °C, in particular of at least 37 °C, in order to have pure ethylene carbonate in its liquid phase.
Propylene carbonate: This material again has a high relative permittivity, see e.g. Xinli You et al in 2015, ECS Trans. 69 107.
Dimethyl sulfoxide (DMSO): This material again has a high relative permittivity, see J. I. Bhat et al., Arch. Appl. Sci. Res., 2011, 3 (5):362-380.
Dimethyl carbonate: Dimethyl carbonate is particularly advantageous when performing measurements on elements of batteries because it is commonly used in batteries and therefore may remain on the sample after the measurement, see e.g. I. Daniels et al. in J. Phys. Chem. C 2017, 121, 2, 1025-1031 https://doi.org/10.1021/acs.jpcc.6b10896.
Alcohols, in particular methanol and/or ethanol, or mixtures thereof, see e.g. R. Augustine et al. in Electronics Letters, Vol. 50(5), pp. 358-359.

Advantageously, the organic liquid consists of at least 50% of one or more of the above high-permittivity liquids.

For low-frequency applications, i.e. for probe signals up to frequencies of around 1 MHz, the mediator may advantageously be an electrolyte, i.e. a material that contains ions and can be decomposed by electrolysis. For example:
A water-based electrolyte may be used, such as NaCl solution.
An electrolyte based on an organic solvent may be used, such as LiPF₆ dissolved in ethylene carbonate or dimethyl carbonate, e.g. 1.0 M LiPF₆ EC/DMC.

As mentioned above, at least part of the mediator, in particular all of the mediator, may also be a solid. Solids can be applied and/or removed easily, and/or they may be tailored in more versatile manner to the present application as outlined in the following.

Advantageously, a solid mediator layer is elastically or plastically compressed during the measurement by at least 5%, in particular by at least 10%, in a direction perpendicular, i.e. normal, to surface 12 of sample 4. This ensures that it fills the gap 24 between the sampling tips 10 and sample 4 even if the surfaces are irregular or not well aligned. In addition, for some anisotropic conductive films (see below), such a compression will lead to an anisotropic increase of conductivity in the direction of the compression.

In one embodiment, mediator layer 26 may comprise a film having anisotropic electric conductivity, with the conductivity in the direction perpendicular, i.e. normal, to surface 12 of sample 4 being larger, in particular at least 2 times, in particular at least 10 times larger, than in the directions parallel to surface 12. This allows for improved spatial resolution and for better electrical signal separation between the sampling tips 10.

Anisotropic conductive films are known to the skilled person, see e.g. https://en.wikipedia.org/w/index.php?title=Anisotropic_conductive_film&oldid=1095328911.

Examples of anisotropic conductive films (ACF) include:
Hitachi Anisotropic Conductive Film ANISOLM AC-7206U-18
Nematic Liquid Crystal Composite Materials, such as e.g. described by M. Munna et al. in Technologies 2019, 7, 32; doi:10.3390/technologies7020032
Shin-Etsu Inter-Connector, GB-Matrix type, by Shin-Etsu Polymer Co., Ltd., Japan
Shin-Etsu Inter-Connector, AF type, by Shin-Etsu Polymer Co., Ltd., Japan

For details on the manufacturing process of the Shin-Etso Interconnectors, see e.g. CN102604387A.

Some of these ACF (e.g. the Hitachi Anisotropic Conductive Film) have to be compressed between the probe head and the sample during the measurement in order to generate anisotropic conductivity, advantageously under a compression of at least 10%.

Others (the Nematic Liquid Crystal Composite Materials) need an electrical field, in particular a DC electrical field or low-frequency field (i.e. a field with a frequency below 1 MHz) to be applied over the film during the measurement in order to generate anisotropic conductivity. Such an electrical field may e.g. be generated by applying a DC voltage (in addition to the AC voltages of the probe signals) to the sampling tips 10 in respect to sample 4 and/or carrier 14.

Others materials are inherently structured for anisotropic conductivity, such as the Shin-Etsu Inter-Connectors.

If mediator layer 26 is a solid layer and the measurement involves displacing probe head 2 in respect to sample 4 in a direction parallel to surface 12 in order to perform a scanning:
In a preferred embodiment, before displacing probe head 2 in respect to sample 4 in the direction parallel to surface 12, the distance D between probe head 2 and sample 4 is increased, e.g. by means of actuator 16, then probe head 2 is displaced in respect to sample 4 in the direction parallel to surface 12, and then distance D is reduced again. This sequence of steps generates a “hopping” of probe head 2 along sample 4 and allows to reduce and/or eliminate the frictional forces between probe head 2, mediator layer 26, and sample 4.
In another embodiment, during such displacement, the distance D between probe head 2 and sample 4 remains unchanged, and displacement mechanism 22 is adapted to overcome any frictional forces between probe head 2, mediator layer 26, and sample 4.

In yet another embodiment, mediator layer 26 may comprise the combination of a solid mediator sublayer and a liquid mediator sublayer. This reduces frictional forces and makes it easier to displace probe head 2 in respect to sample 4 in the direction parallel to surface 12.

In another embodiment, the solid forming part or all of the mediator layer may be a gel, e.g. silica gel containing water.

### Mediator Placement

The present technique can be used in a laboratory setting, e.g. for the off-line quality control of individual, select samples, but it may also be applied on-line or in-line, as part of a manufacturing process where all manufactured products are sampled while they are being produced.

In particular (but not only) in on-line applications, the invention can e.g. be implemented as a roll-to-roll process. This is suitable for applications where sample 4 is a flexible film that can be wound onto a roll.

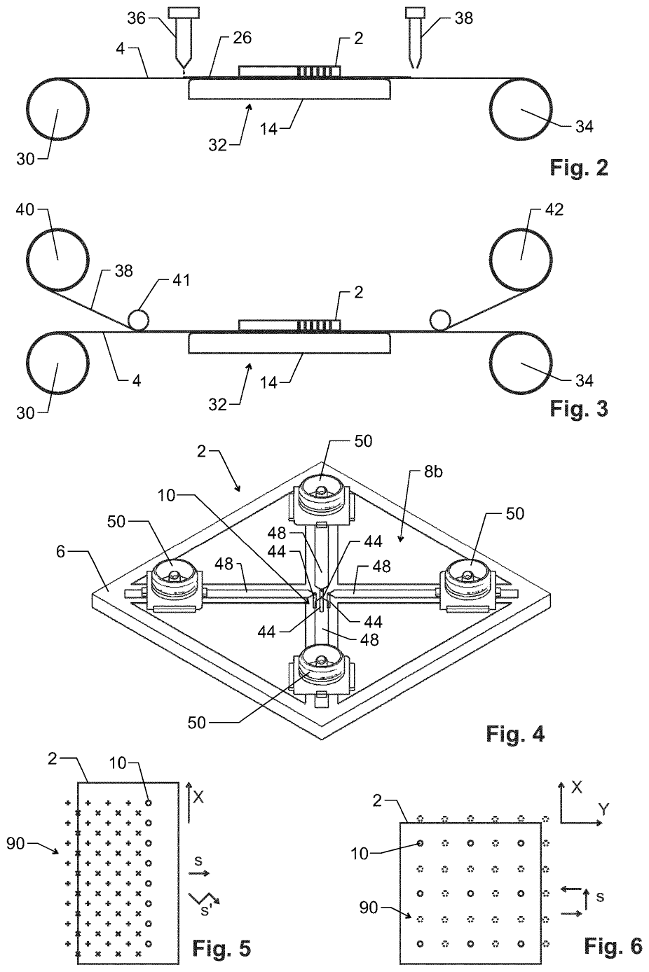

FIG. 2 shows a possible implementation of such a roll-to-roll process.

Here, prior to the measurement, sample 4 is wound onto a first sample roll 30. It is unwound and moved to the measurement location 32, where it is brought into measurement range of probe head 2. Advantageously, a carrier 14 is located at a suitable distance from probe head 2, and sample 4 is guided by carrier 14 to maintain it at a suitable distance from probe head 2. As in the first embodiment, an actuator and a positioning sensor (not shown in FIG. 2) may be provided to fine-tune the relative distance and attitude of probe head 2 and sample 4 at measurement location 32.

As the sample 4 is displaced past probe head 2, its surface is scanned by means of the sampling tips.

Note: For illustrative purposes, FIGS. 2 and 3 show several sampling tips arranged behind each other along the direction of movement. However, the sampling tips may also be arranged along a line extending transversally to the direction of movement. For more details on the arrangement of the sampling tips 10 in respect to the direction of movement, see the section “Scanning process” below.

After the measurement, sample 4 may be wound onto a second sample roll 34. Alternatively, it may be stored in a different manner and/or moved to other processing stages.

In the embodiment of FIG. 2, a liquid mediator layer 26 is used. It is positioned, namely deposited, onto sample 4 prior to performing the measurement. After performing the measurement, it is advantageously removed therefrom.

Hence, in one embodiment, the method comprises the step of depositing the mediator layer onto the sample 4 prior to performing the measurement.

In the shown embodiment, depositing the mediator layer onto sample 4 is e.g. implemented by providing a nozzle arrangement 36, which applies the mediator layer onto sample 4, e.g. in an inkjet printing process and/or a spraying process.

To remove the mediator layer after the measurement, a dryer, such as a hot-air blower 38, may be used.

FIG. 3 shows another implementation of a roll-to-roll process where mediator layer 26 comprises a solid mediator film 38.

In this embodiment, the handling of sample 4 is the same as in the previous one, i.e. sample 4 is unwound from first sample roll 30, conveyed to measurement location 32, and then e.g. wound onto second sample roll 34.

Mediator film 38 is unwound from a first mediator roll 40, placed on substrate 4 e.g. by means of a roller 41, and fed towards measurement location 32, where it is inserted between probe head 2 and sample 4. After passing measurement location 32, mediator film 38 may e.g. be wound back onto a second mediator roll 42, or it may be stored or discarded in different manner.

In other words, the method advantageously comprises at least the following steps:
Unwinding the mediator film 38 from a first mediator roll 40.
Inserting the unwound film 38 between probe head 2 and sample 4.
Performing, at measurement location 32, the measurement with the film 38 inserted between the probe head and the sample.

In this embodiment, the mediator layer 26 is deposited by means of the roll mechanism including roll 40 and roller 41, on sample 4.

Optionally, after measurement location 32, mediator film 38 may be wound onto a second mediator roll 42.

The embodiments of FIGS. 2 and 3 can be combined by depositing a liquid sublayer of the mediator layer onto mediator film 38 before or upon inserting it between probe head 2 and sample 4, advantageously on the side of mediator film 38 that faces probe head 2, thereby reducing friction.

The mediator layer may also be applied by means of a printing process, e.g. by means of inkjet printing as mentioned above or in a roller-transfer printing process.

In yet another embodiment, stamping may be used to apply the mediator layer. In stamping, the sample and/or the probe head are, prior to the measurement, brought into contact with a mediator reservoir, e.g. a stamp pad, where mediator material is transferred, advantageously as a liquid, to the sample or probe head. Then, the sample and probe head are brought into their measurement configuration to carry out the actual measurement with the mediator layer between them.

Hence, the present method may comprise the step of applying at least part of the mediator layer to the sample and/or the probe head by means of at least one of the following techniques:
printing, in particular inkjet printing, and
stamping.

### Probe Head

Probe head 2 comprises, as mentioned, an insulating substrate 6 and a plurality of conductive sampling tips 10.

As e.g. shown in FIG. 1, each sampling tip 10 advantageously comprises an electrically conducting via 44 extending through substrate 6 from first side 8a to second side 8b. Optionally, the sample tip 10 may also comprise a conductive protrusion 46 on first side 8a, projecting over fist side 8a and into gap 24.

For example, conducting via 44 may be of tungsten and arranged in an anisotropically etched opening of substrate 6 while protrusion 46 may be of platinum, gold, platinum-iridium, and/or diamond.

Diamond is particularly advantageous because of its good mechanical stability. It has a high relative permittivity and can therefore be used to focus the (AC) probe signal at a given location. Further, the diamond may be doped, e.g. by boron, in order to increase its conductivity.

The sampling tips have to guide the electromagnetic field to the desired locations on the substrate. Hence, they advantageously have, at the frequency of the probe signals, a relative permittivity and/or conductivity that is different to, in particular higher than, the relative permittivity and/or conductivity of the substrate. For conductivity, an advantageous implementation of the tips has more than 100 times higher conductivity than the substrate.

FIG. 4 shows an embodiment of a probe head 6 with a comparatively small number (4) of sampling tips 10 illustrating how the sampling tips may be connected to processing electronics 20.

As can be seen, probe head 6 comprises, on its second side 8b, i.e. on the side of substrate 6 that faces away from sample 4 during the measurement, a plurality of electrical leads 48 and of connectors 50. Each lead 48 connects one of the connectors 50 to one of the vias 44 of a sampling tip 10.

This type of arrangement allows to place the sampling tips close to each other while providing more room (on side 8b of substrate 6, where the electrical properties of sample 4 do not affect the signals) for the connections with the processing electronics 20.

In the shown embodiment, the connectors 50 are coaxial plug-type HF connectors, but they may e.g. also comprise other connector types, such as direct connectors to an interposer layer arranged on top of substrate 6 and forming an interface to processing electronics 20.

For good spatial resolution, the diameter of each tip is advantageously smaller than 200 μm, in particular smaller than 20 μm.

### Positioning Sensor

As mentioned, the apparatus is advantageously equipped with a positioning sensor 18 (FIG. 1) for monitoring the relative distance and tilt of probe head 2 and sample 4.

In the embodiment as shown in FIG. 1, the sensor 18 is an optical sensor shining “probe light” transversally through substrate 6 and detecting “returning light” reflected from substrate 6 and sample 4. The returning light is analyzed to measure the relative distance and/or tilt between probe head 2 and sample 4.

In the shown embodiment, the probe light is generated by means of a light source 60, the light of which is e.g. sent through a diaphragm or mask 62 in order to generate an optical structure, such as a light spot. This structure is projected, e.g. by means of lenses 64, 66, onto first surface 8a, i.e. onto the sample-facing surface of substrate 6. The reflection of this structure is projected as an image, e.g. by means of lenses 66, 68, onto a camera 70. The relative distance and/or tilt can then be detected from said image. A beam splitter 72 is provided for separating the probe light and the returning light.

Techniques for performing this type of measurement are described by S. Ernst et al. in “A Planar Scanning Probe Microscope”, arXiv:1805.03199.

In one embodiment, the image projected onto camera 70 comprises a first sub-image returning from the sample-facing surface 8a of substrate 6 and a second sub-image returning from sample 4. The offset between these sub-images is a measure of the tilt between substrate 6 and sample 4. The relative size of the structure (e.g. the light dot) in these sub-images is a measure of the distance between substrate 6 and sample 4.

In another embodiment, also as described in S. Ernst et al. in the reference above, the attenuation of total internal reflection at first surface 8a can be used to assess the distance D.

In yet another embodiment, an interferometric measurement may be used to measure the tilt and/or distance.

Hence, in more general terms, the method advantageously comprises at least the following steps:
Generating, by means of probe light, an optical structure (e.g. a dot of light) on a sample-facing surface, i.e. on the first surface 8a, of substrate 6.
Projecting an image of a reflection of the optical structure by means of imaging optics, e.g. by means of the lenses 66, 68, onto a camera 70.
Detecting the relative distance D and/or tilt between probe head 2 and sample 4 from said image.

Further, again in general terms, the apparatus advantageously comprises at least the following components:
A light source 60 positioned to send light at a center measurement wavelength transversally through substrate 6.
A camera 70 positioned to receive light reflected from substrate 6.
An actuator 16 for changing the relative tilt and/or distance between probe head 2 and the sample 4.
A control unit 27 connected to control actuator 16 in response to an image recorded by camera 70.

In order to perform this type of optical measurements, substrate 6 needs to be transparent at the wavelength of the used light. Also, mediator layer 26 should be transparent at said wavelength as well.

The wavelength of the light may e.g. be in the visible or NIR spectrum between 400 nm and 2000 nm.

As mentioned, the positioning sensor 18 may use the reflection of the probe light from sample-facing surface 8a of substrate 6. It must be noted that the reflectivity at said surface is affected by the presence and refractive index of mediator layer 26.

If the position measurement is to be carried out while mediator layer 26 is present in gap 24, and in the absence of a coating at surface 8a, the reflectivity at surface 8a depends on the refractive indices of mediator layer 26 and substrate 6. If the two indices are very close to each other, reflectivity may be low. Hence, in an advantageous embodiment, a reflective coating is located on sample-facing surface 8a in order to tune the reflectivity to a desired value.

It must be noted, though, that the position measurement may also be carried out in the absence of mediator layer 26. In this case too, a coating may be located on sample-facing surface 8a in order to tune to the reflectivity at surface 8a to a desired value.

In another embodiment, sensor 18 may e.g. be a capacitive sensor, a mechanical sensor, or an optical proximity sensor.

In the examples above, sensor 18 is adapted to measure the distance and/or tilt (parallelism) of probe head 2 and sample 4. In addition or alternatively thereto, there may also be a displacement detector adapted to measure the relative displacement between probe head 2 and sample 4 in one or two dimensions parallel the sample-facing surface 8a of substrate 6. For more details, see the section “Detecting displacement” below.

### Signal Processing

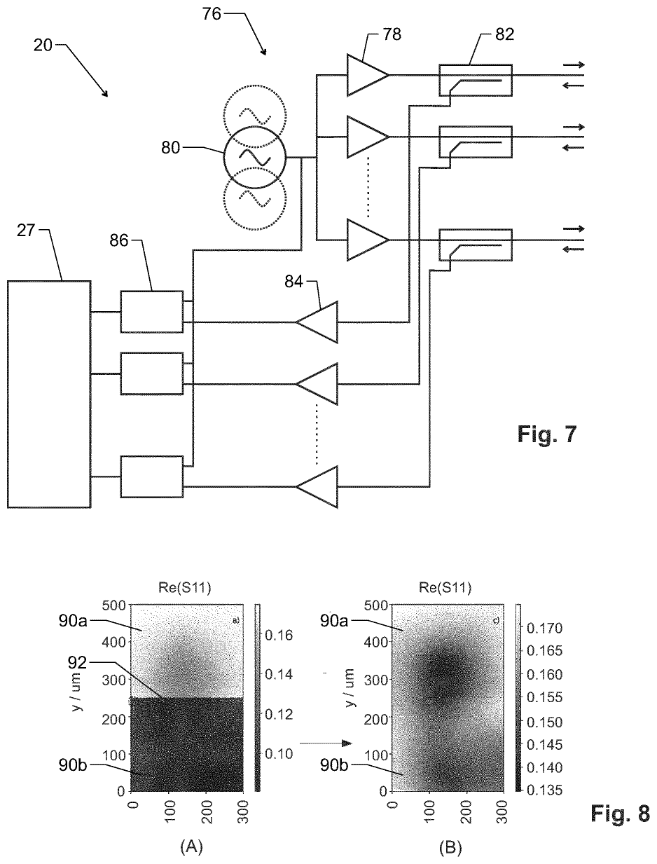

As mentioned, the present apparatus comprises processing electronics 20 for generating the probe signals for the sampling tips 10 and for analyzing the return signals from the sampling tips 10. An example of such electronics is shown in FIG. 7.

Typically, processing electronics 20 comprises a vector network analyzer for determining the complex reflectivities of the sampling tips 10.

For example, the processing electronics comprise one or more AC signal sources 76 for generating the probe signals. In the shown embodiment, for example, there are several signal sources, each with its own amplifier 78, but they all share the same oscillator 80. Alternatively, each signal source may have its own oscillator 80 (as shown in dotted lines). In yet another embodiment, there may be only a single signal source generating an AC signal that is applied to all sampling tips 10.

The AC signals are sent through directional couplers 82 and from there to the sampling tips 10.

The return signals are branched off in the directional couplers 82. They may be amplified in amplifiers 84.

Lock-in amplifiers 86 are provided for measuring the amplitude and phase of the return signals. The results of the measurement are fed to control unit 27 for further analysis.

The electronics 20 may be implemented as analog circuitry and/or, at least in part, as digital circuitry, e.g. as FPGA circuitry.

For high measurement speed, the processing circuitry has advantageously adapted to perform measurements on several sampling tips 10 concurrently. Sequential measurements can, however, also be used, in which case multiplexers and demultiplexers may be provided to reduce the number of some of the components.

For concurrent measurements, the frequencies of the individual probe signals may be chosen to be different from each other. In this case, even if there is crosstalk between the sampling tips 10, the lock-in amplifiers can distinguish between the return signals from the individual sampling tips.

The frequency of the sampling signals is advantageously at least 0.5 GHz, e.g. in the range between 0.5 GHz and 20 GHz.

### Scanning Process

The scanning process is advantageously adapted to various aspects of the device, such as to the desired resolution, the sample size, the means of sample transport, the geometry of the sampling tips, etc.

For example, and as shown in the embodiment of FIG. 5, the sampling tips 10 may be arranged in a one-dimensional, regular array extending along a direction X. In this case, the probe head 2 is displaced relative to sample 4 along a scan direction s transversally to direction X and parallel to the sample-facing surface of the substrate. Advantageously, scan direction s is perpendicular to direction X.

While probe head 2 is being displaced in respect to sample 4, repetitive measurements are carried out, thereby generating a two-dimensional scan in a region 90 as illustrated with + marks in FIG. 5.

This type of scan can e.g. be used in combination with a roll-to-roll process where scan direction s corresponds to the direction of displacement of sample 4 as it passes measurement location 32.

Alternatively to a linear displacement motion along scan direction s, a meandering displacement s′ may be used, which allows to increase resolution in region 90 by adding a further set of differently offset points of measurement, as illustrated with × marks in FIG. 5.

In another embodiment, as illustrated in FIG. 6, the sampling tips 10 may be arranged in a two-dimensional, regular array extending along directions X and Y, with X and Y advantageously being perpendicular.

In this case, the path of displacement of probe head 2 in respect to sample 4 may be two-dimensional, within the plane of X, Y, e.g. consisting of a first displacement along Y, a second displacement along X, and a third displacement along −Y as illustrated in FIG. 6, with each displacement being over an integer fraction of the sampling tip spacing along X and Y, respectively, thereby generating a measurement in a region 90 at a grid having a higher resolution than the array of sampling tips 10. The displacements occur parallel to the sample-facing surface of the substrate.

In addition to measuring a region 90 of the sample by displacing probe head 2 in respect to sample 4 and concurrently performing measurements, several such regions 90 may be tiled over sample 4 by macroscopically displacing probe head 2 in respect to sample 4 and repeating the measurement. This is illustrated in FIG. 8, with two such regions 90a and 90b arranged side by side. The example shows the real part of the returned signal. The gray scale (dithered in the figure) corresponds to the magnitude of the signal.

Part (A) of FIG. 8 shows the uncorrected value of the real part of the return signal. As can be seen, there is a significant offset at the border between the two regions 90a, 90b. This offset may e.g. be caused by a small shift between probe head 2 and sample 4 between the measurements of the two regions 90a, 90b, by different couplings between the tips and the sample, by inter-tip differences, and/or differences in the HF paths or impedance matches for the individual tips, and/or differences in the associated detectors, directive elements, and sources. Such an offset can be corrected by scaling and/or offsetting the returned signals of the two regions 90a, 90b in such a manner that the total differences between values of the two regions along the interface 92 becomes minimal, e.g. my minimizing the sum of the squares of the offsets between neighboring pixels along the interface.

Hence, in more general terms, the measurement method may comprise the following steps:
Scanning a first region 90a of sample 4 by means of the probe head 2.
Scanning a second region 90b of sample 4 by means of probe head 2. The second region 90b is adjacent to the first region 90a.
Mathematically correcting the return signal (i.e. a value descriptive of the amplitude and/or phase of the return signal) by minimizing the offset between scan points of the first region 90a and neighboring scan points of the second region 90b along the interface 92 between the first region 90a and the second region 90b.

Advantageously, such a correction may comprise a scaling and or offsetting of the return signal of the first region and/or of the second region. However, non-linear corrections may be used as well.

### Measuring Inter-Tip Transmission

As explained above, the present technique allows to measure the reflectivities of the sampling tips 10. In other words, a probe signal is applied to a given sampling tip 10, and the phase and/or amplitude of the signal returning from this given sampling tip 10 is measured. This provides a measure of the properties of the sample at the area of the given sampling tip 10.

Alternatively or in addition thereto, the present technique allows to measure inter-tip transmission. In this case, a probe signal is applied to a first sampling tip 10, and the phase and/or amplitude of the signal returning from a second sampling tip 10 (different from the first sampling tip) is measured. This provides a measure of the properties of the sample at the area between the first and second sampling tips.

The measurement of one or more inter-tip transmissions typically provides a better signal-to-noise ratio. When sending a probe signal to a given sampling tip, the return signal from the same sampling tip not only comprises the signal reflected at the sampling tip but may also include components from signals reflected from other parts of the signal path between processing electronics 20 and the given sampling tip, which may affect the quality of the measured reflectivity. On the other hand, when sending a probe signal to the first sampling tip while measuring a return signal from the second sampling tip, the return signal will typically comprise less undesired signal components.

Hence, the present method may comprise at least one of the steps of
a) Sending a probe signal to a given sampling tip and measuring the reflection from the given sampling tip. Advantageously, this is carried out for several sampling tips in order to measure the reflection of several sampling tips.
b) Sending the probe signal to a first sampling tip and measuring the return signal from a second sampling tip different from the first sampling tip. Advantageously, this is carried out for several different pairs of first and second sampling tips.

Advantageously, steps a) and b) are combined.

This technique can be generalized to any type of multi-tip configurations, e.g. where probe signals are applied at a first set of sampling tips and transmission is detected from a second set of sampling tips, with the first and/or second set comprising more than one sampling tip.

### Detecting Displacement

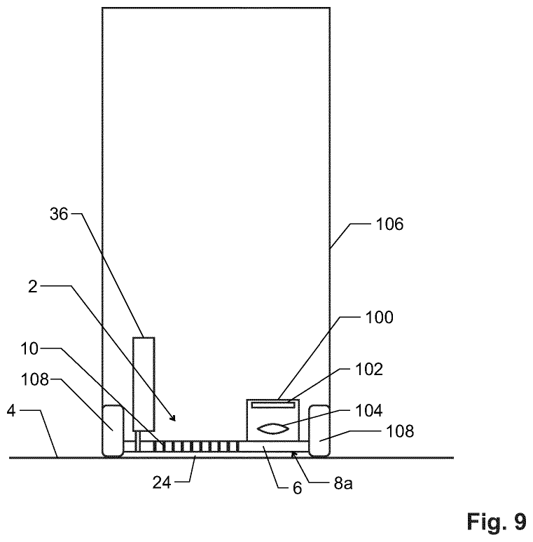

FIG. 9 illustrates some further aspects of the present technique. Here, probe head 2 comprises a displacement detector 100 adapted to quantitatively assess, i.e. measure, the displacement between probe head 2 and sample 4 in one or both directions parallel to substrate 6. This allows to better correlate the measurements at the sampling tips 10 to the relative position, along the directions parallel to the substrate, of probe head 2 and sample 4.

Displacement detector 100 advantageously comprises a camera 102 and imaging optics 104 adapted to record images of the surface of sample 4. Digital image correlation between different images can then be used to determine offsets and, thereby, to determine the movement of probe head 2 in respect to sample 4. This type of technique is widely known from optical mice.

Alternatively, displacement detector 100 may e.g. be based on specular reflection as e.g. described in U.S. Pat. No. 7,321,359.

In yet other embodiments, a gyroscope, accelerometer, or magnetometer can be used.

Displacement detector 100 may also detect the orientation of probe head 2 in order to record a surface contour of sample 4 in three dimensions.

Hence, advantageously, the present method comprises the step of measuring a relative displacement in at least one direction parallel to the substrate 6. In particular, the measured displacement is then used to assign different measurements (i.e. measurements made at different times) at the sampling tips 10 to different relative positions between probe head 2 and sample 4.

When providing a displacement detector 100, the apparatus is particularly suited to be manually applied to and displacement along the sample 4. However, such a displacement detector can also be advantageously used in fixed installations, such as the ones shown in FIGS. 1-3, where probe head 2 is not manually operated but rather installed on a scaffold or such.

To do so, and as illustrated in FIG. 9, it may e.g. comprise a housing 106 suitable to be seized and moved manually.

Housing 106 may also comprise one or more spacers 108 mounted to substrate 6 and projecting over sample-facing surface 8a of substrate 6 by a distance that is at least as large as the distance by which the sampling tips 10 project over surface 8a, thereby protecting the sampling tips 10 from mechanical damage.

In the embodiment of FIG. 9, processing electronics 20 is advantageously incorporated, at least in part, in housing 106.

Further, as described above, the apparatus may comprise a depositing device 36 adapted to feed the mediator material into gap 24. Using a mediator layer for a manually operated device is particularly useful because, as explained above, the mediator layer makes the measurement less dependent on the distance between the sampling tips 10 and the sample 4.

Displacement detector 100 may form a detector separate from positioning sensor 18, or the two devices may be combined, e.g. by using the same camera.

### Samples, Applications

The present method and apparatus can be used to characterize various samples as long as the samples have a substantially flat surface (flat as compared to the width of gap 24) and their electrical properties (at the used measurement frequency) vary sufficiently. For example, the technique can be applied to the following types of samples:
Battery electrodes or battery separators: Battery electrodes e.g. comprise a copper substrate coated with graphite. Inhomogeneities of the graphite coating lead to inhomogeneous electrical properties and can be detected by the present technique. Also, after battery forming, the solid electrolyte interphase (SEI) can be characterized. A separator, which is located between the electrodes of a battery cell, is a dielectric layer intended to physically separate the electrodes while being permeable to the electrolyte. The present technique can be used to detect defects in such separators.
Solar panels: The electrical surface structure of solar panels can be scanned for defects. During production, conductivity and relative permittivity of different layers can be characterized.
Semiconductors: Quality inspection on complete wafers or individual chips. High resolution scanning of complete wafers possible.
Printed electronics: Measurement of conductivity
Display production: Quality control
Biological samples: Electrical properties of biological tissue, in particular for detecting cancer or skin issues.

The application to biological samples is particularly useful for detecting skin cancer or other skin issues. In that case, a device as e.g. shown in FIG. 9 can be manually applied to a patient's skin and be moved along it.

### Notes

Even though the term “tips” is used for the sampling tips 10, it must be noted that the sampling tips 10 are not necessarily pointed. They may e.g. form rounded protrusions over first surface 8a, as shown in FIG. 1. Or the tips may even be flush with first surface 8a, and/or they may be covered by a thin, insulating protective layer (not shown) of e.g. a few nm thickness. They are, however, arranged at first surface 8a of substrate in the sense that the electrical fields generated by the probe signals extend beyond first surface 8a all the way to sample 4, such that the reflection coefficient of the probe signals is a function of the local electrical properties of sample 4.

In most of the examples above, the tips form a regular array, i.e. an array where the tips are equidistant from their nearest neighbors. Alternatively, though, irregular arrays of tips can be used, e.g. in order to have a higher resolution in some parts of the probe head than in other parts.

While there are shown and described presently preferred embodiments of the invention, it is to be distinctly understood that the invention is not limited thereto but may be otherwise variously embodied and practiced within the scope of the following claims.

1. A method for scanning a sample using Scanning Microwave Microscopy comprising performing a measurement by passing the sample past a probe head, which probe head has a substrate and an array of sampling tips arranged on said substrate, said measurement including
feeding AC probe signals to the sampling tips,
measuring amplitudes and/or phases of a plurality of return signals returning from the sampling tips, and
deriving spatially resolved properties of the sample from the return signals,
wherein, during the measurement, a gap between the sampling tips and the sample is filled by a liquid and/or solid mediator layer.

2. The method of claim 1 wherein the mediator layer comprises a liquid.

3. The method of claim 2 wherein the liquid comprises at least 50% water.

4. The method of claim 2 wherein the liquid comprises at least 10% of an organic liquid.

5. The method of any of claim 1 wherein the mediator layer comprises a solid.

6. The method of claim 5 wherein the mediator layer is compressed during the measurement by at least 5% in a direction normal to a surface of the sample.

7. The method of claim 5 wherein the mediator layer comprises a mediator film having anisotropic electric conductivity, with the conductivity normal to the surface of the sample being larger than in the directions perpendicular thereto

8. The method of claim 5 wherein the mediator layer comprises a solid mediator film and wherein the method comprises inserting the mediator film between the probe head and the sample.

9. The method of claim 8 comprising
unwinding the mediator film from a first mediator roll,
inserting the unwound mediator film between the probe head and the sample,
performing, at a measurement location, the measurement with the mediator film inserted between the probe head and the sample.

10. The method of claim 1 comprising
unwinding the sample from a first sample roll,
performing, at a measurement location, the measurement on the sample while the sample is being transported away from the first sample roll.

11. The method of claim 1 comprising
positioning the mediator layer on the sample and/or the probe head prior to performing the measurement and
removing the mediator layer after performing the measurement.

12. The method of claim 1 comprising depositing the mediator layer onto the sample and/or the probe head prior to performing the measurement.

13. The method of claim 1 wherein the substrate is transparent and wherein the method further comprises
shining probe light transversally through said substrate,
detecting returning light reflected from the substrate, and
controlling a relative distance and/or tilt between the probe head and the sample using the returning light.

14. The method of claim 13 further comprising
generating, by means of the probe light, an optical structure on a sample-facing surface of the substrate,
projecting, by means of imaging optics (66, 68), an image of a reflection of the optical structure onto a camera,
detecting the relative distance and/or tilt from said image.

15. The method of claim 1 wherein, during the measurement, the mediator layer has a thickness of at least 10 nm.

16. The method of claim 1 comprising
scanning a first region of the sample,
scanning a second region of the sample, with the second region being adjacent to the first region,
mathematically correcting the return signal by minimizing an offset between scan points of the first region (90a) and neighboring scan points of the second region (90b) along an interface between the first region and the second region (90b).

17. The method claim 1 comprising applying at least part of the mediator layer to the sample and/or the probe head by means of at least one of:
printing and
stamping.

18. The method of claim 1 comprising sending a probe signal to a given sampling tip and measuring the reflection from the given sampling tip.

19. The method of claim 1 comprising sending the probe signal to a first sampling tip and measuring the return signal from a second sampling tip different from the first sampling tip.

20. The method of claim 1 further comprising measuring a relative displacement between the probe head and the sample in at least one direction parallel to the substrate.

21. The method of claim 1 wherein the mediator layer includes an electrolyte comprising ions.

22. An apparatus for scanning a sample using Scanning Microwave Microscopy comprising
a probe head having an insulating substrate and an array of conductive sampling tips arranged on said substrate,
one or more AC signal sources electrically connected to the sampling tips,
a plurality of amplitude and/or phase detectors electrically connected to the sampling tips,
a sample carrier, and
a depositing device for depositing a liquid and/or solid mediator layer onto the sample and/or probe head.

23. The apparatus of claim 22 further comprising a displacement mechanism adapted and structured to displace a sample in the sample carrier past the probe head.

24. The apparatus of claim 22 wherein said probe head further comprises a displacement detector adapted to quantitatively assess a displacement between the probe head and the sample in at least one direction parallel to the substrate.

25. The apparatus of claim 22 further comprising at least one spacer (108) mounted to the substrate and projecting over a sample-facing surface of the substrate by a distance at least as large as the sampling tips.

26. The apparatus of claim 22 further comprising
a light source positioned to send light at a measurement wavelength transversally through the substrate,
a camera positioned to receive light reflected from the substrate,
an actuator for changing a relative tilt and/or distance between the probe head and the sample, and
a control unit connected to control the actuator in response to an image recorded by the camera.

27. The method of claim 1 wherein the probe head comprises a regular array of at least three sampling tips arranged on said substrate.

28. The method of claim 1 wherein said array is a one-dimensional array.

29. The method of claim 1 wherein said array is a two-dimensional array.

30. The method of claim 1 wherein each sampling tip comprises an electrically conducting via extending through the substrate.

31. The method of claim 30 wherein the probe head further comprises, on a side of the substrate facing away from the sample, a plurality of electrical leads and a plurality of connectors, wherein each lead connects one of the connectors to one of the vias.

32. The method of claim 1 wherein the sampling tips are immovably arranged on the substrate.

33. The method of claim 1 comprising at least one of
scanning electrodes or separators of battery cells,
scanning at least one of semiconductors, printed electronics, and display components, and
scanning biological samples.
